(19) United States
(12) Patent Application Publication
(10) Pub. No.: US 2025/0136246 A1
(43) Pub. Date: May 1, 2025

(54) SNOW VEHICLE

(71) Applicant: Stephan Dallyn Waechtler, Montpelier, ID (US)

(72) Inventor: Stephan Dallyn Waechtler, Montpelier, ID (US)

(21) Appl. No.: 18/933,746

(22) Filed: Oct. 31, 2024

Related U.S. Application Data
(60) Provisional application No. 63/594,640, filed on Oct. 31, 2023.

(51) Int. Cl. B62M 27/02

(52) U.S. Cl. CPC B62M 27/02

(57) ABSTRACT

Examples of the subject disclosure describe a snow vehicle and a powertrain for propelling the snow vehicle over terrain. The powertrain, in certain examples, includes a propulsion unit configured to rotate a drive gear which is disposed on a first side of the propulsion unit. The powertrain also includes a first jackshaft having a first end which is rotationally coupled with the drive gear via a flexible loop, and a second end which is disposed on an opposite side of the propulsion unit and is coupled with a primary clutch. The powertrain also includes a second jackshaft having a first end coupled with a chain gear, and a second end is coupled with a secondary clutch.

### CROSS-REFERENCES TO RELATED APPLICATIONS

This application claims the benefit of U.S. Provisional Patent Application No. 63/594,640 entitled “SNOW VEHICLE” and filed on Oct. 31, 2023, for Stephan Dallyn Weachtler, which is incorporated herein by reference

### FIELD

This disclosure relates to snow vehicles and more particularly relates to a snow vehicle with a clutch system mounted on the opposite side of a motor from a driveshaft.

### BACKGROUND

Motorcycles and motorized snow vehicles such as snowmobiles typically include basic components such as a body with a seat to accommodate a rider, an engine for propelling the vehicle, handlebars that connect to a front portion of the vehicle for steering the snow vehicle. However, motorized snow vehicles are typically operated in different conditions than those in which motorcycles are operated. The way an operator rides a motorized snow vehicle with two skis may be different from how an operator rides a motorcycle or from how an operator rides a motorized snow vehicle with one ski. Sometimes motorized snow vehicles with one ski are referred to as snowbikes because motorcycles form the basis of kits to create the snowbikes.

Such kits typically use the motor of the motorcycle to propel the endless track. Unfortunately, the motorcycle motors are underpowered compared to the high-performance motors used in current generation snowmobiles. Furthermore, current snowbikes are not equipped with clutch systems that are commonly used on snowmobiles.

### SUMMARY

A powertrain for propelling a snow vehicle is disclosed. In certain examples, the powertrain includes a propulsion unit configured to rotate a driveshaft, where the driveshaft has an end configured to couple to a drive gear, where the end is disposed on a first side of a vertical plane that aligns with a longitudinal axis defined by the snow vehicle. The powertrain may also include a first jackshaft having a first end and a second end, where the first end is rotationally coupled with the drive gear via a flexible loop, where the second end is coupled with a primary clutch of a continuously variable transmission (CVT) clutch system, and where the second end is disposed on a second side of the vertical plane.

In certain examples, the powertrain also includes a second jackshaft having a first end and a second end, where the first end is coupled with a chain gear, where the second end is coupled with a secondary clutch of the CVT clutch system, and where the second end is disposed on a second side of the vertical plane. The powertrain may also include an automatic tensioner configured to maintain tension on the flexible loop, and where the automatic tensioner is disposed within a perimeter of the flexible loop and applies a tensioning force one of inward or outward on the flexible loop.

The propulsion unit, in certain examples is located forward relative to an endless track, and the primary and secondary clutches are disposed above the endless track. A v-belt configured to couple the primary clutch and the secondary clutch may also be included. In certain examples, a chain is configured to couple the chain gear with an endless track driveshaft.

In certain examples, the powertrain also includes one or more drivers coupled to the track driveshaft, where the one or more drivers are configured to engage the endless track and propel the snow vehicle forward. The propulsion unit may be a dual cylinder internal combustion engine, or a single cylinder internal combustion engine. The internal combustion engine may be configured with an exhaust pipe that is coupled to a front portion of the internal combustion engine and configured to pass below the internal combustion engine. In certain examples, the secondary clutch comprises a reverse-cut helix for counter-clockwise operation of the secondary clutch. The snow vehicle further comprises a single ski.

A snow vehicle is also disclosed that implements the powertrain. A method that propels the snow vehicle is also disclosed.

### BRIEF DESCRIPTION OF THE DRAWINGS

In order that the advantages of the disclosure will be readily understood, a more particular description of the disclosure briefly described above will be rendered by reference to specific examples that are illustrated in the appended drawings. Understanding that these drawings depict only typical examples of the disclosure and are not therefore to be considered to be limiting of its scope, the disclosure will be described and explained with additional specificity and detail through the use of the accompanying drawings, in which:

FIG. 1 is a perspective view diagram of a snowbike, in accordance with one or more examples of the present disclosure;

FIG. 2 is a perspective view diagram illustrating one example of a drive system of a snowbike;

FIG. 3 is a front view diagram of the snowbike, in accordance with examples of the subject disclosure;

FIG. 4 is perspective view diagrams illustrating one example of the primary and secondary clutches, of the snowbike in accordance with examples of the subject disclosure;

FIG. 5 is another perspective view diagram illustrating another example of the primary and secondary clutches of the snowbike, in accordance with examples of the subject disclosure;

FIG. 6 is a perspective view diagram illustrating one example of a reverse-cut helix of a secondary clutch, in accordance with examples of the subject disclosure;

FIG. 7a is a schematic block diagram illustrating one example of a top-down view of the powertrain of the snowbike, in accordance with examples of the subject disclosure;

FIG. 7b is a schematic block diagram illustrating one example of the automatic tensioner in accordance with examples of the subject disclosure; and

FIG. 8 is a schematic flowchart diagram illustrating one method of propelling a snow vehicle in accordance with examples of the subject disclosure.

### DETAILED DESCRIPTION

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more examples. In the following description, numerous specific details are provided to give a thorough understanding of examples of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the examples are described below with reference to schematic flowchart

diagrams and/or schematic block diagrams of methods, apparatuses, or systems. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted examples. For instance, an arrow may indicate a waiting or monitoring period of unspecified duration between enumerated steps of the depicted example.

The description of elements in each figure may refer to elements of proceeding figures. Like numbers refer to like elements in all figures, including alternate examples of like elements.

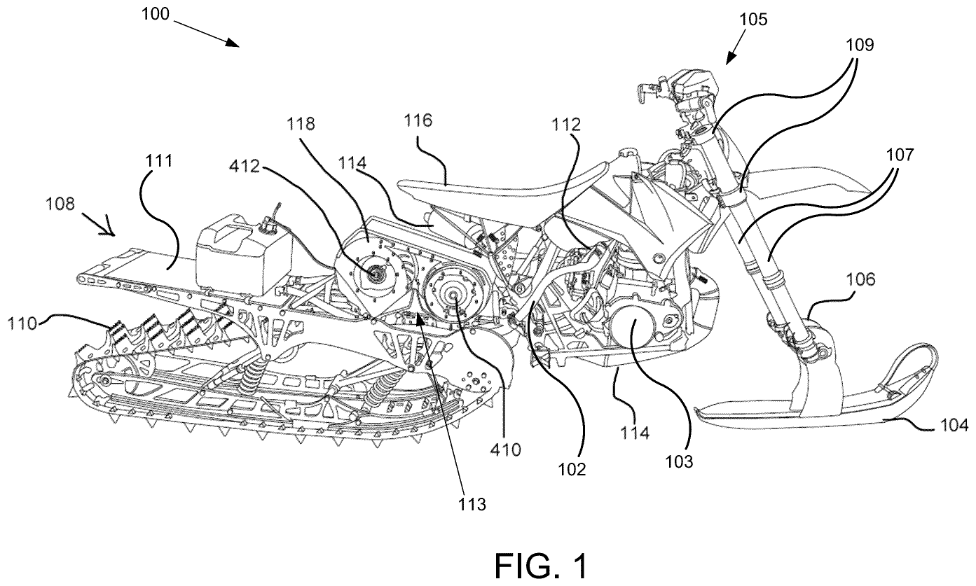

FIG. 1 is a perspective view diagram of a snowbike 100, in accordance with one or more examples of the present disclosure. The snowbike 100 includes a frame 102 that can either be a custom-built frame or a motorcycle frame. Examples of the present disclosure relate to snow vehicles including snowbikes and/or snowmobiles and, in particular, to a snowbike 100 having a continuously variable transmission (CVT) clutch system that is not directly coupled to a driveshaft of a motor. In this sense, the clutch system is separate or “distributed” from the motor.

Traditional snow vehicles are configured with the primary clutch of the CVT clutch system directly coupled to the driveshaft of a motor. This, unfortunately, requires that the clutch system be mounted to the side of the motor. In a traditional snowbike, a CVT clutch system mounted to the side of the motor is not desirable for many reasons including ergonomics. As such, traditional snowbikes have used the transmission of the motorcycle and required that the rider shift the gears in a traditional manner using the gear-shift lever. Constantly shifting the transmission of the motorcycle is tedious and difficult in snowy conditions while wearing bulky snow gear. Beneficially, the separate or distributed CVT clutch system of the present disclosure allows for the inclusion of the CVT clutch system on a snowbike while not destroying the reasons why snowbikes are popular. One of these reasons is that the snowbike is narrow and has the ergonomics of an off-road motorcycle. Another benefit of the distributed CVT clutch system is the ability to accommodate larger motors within the frame of the snowbike.

When referring to the figures, the use of the terms “front”, “rear”, “top”, and “bottom” refer to the orientation of the snowbike in the respective depicted figure as if a rider was seated on the snowbike in a normal manner. In other words, the “front” of the snowbike 100 refers to the portion of the snowbike 100 that is in front of the rider. Likewise, the “right side” of the snowbike 100 is the side of the snowbike that corresponds to the “right side” (e.g., right leg and right arm) of the rider.

In certain examples, the snowbike 100 is formed of a front portion that resembles an off-road motorcycle, and a rear portion that resembles a snowmobile. The rear portion may be sold as a kit for converting an off-road motorcycle into a snowbike. In other examples, the snowbike 100 may be sold as a complete, ready-to-run unit. The motorcycle portion of the snowbike 100 includes the frame 102, which houses a propulsion unit 103 (i.e., motor or engine) coupled to a steering assembly 105. The steering assembly 105 includes handlebars and a front suspension assembly that includes two fork tubes 107 coupled to the frame 102 via a triple clamp 109. A ski 104 is coupled to the fork tubes 107 at the front of the snowbike 100. It is contemplated that the front ski 104 may be connected to the frame 102 via any suitable steering mechanism.

The rear portion that resembles a snowmobile includes a track assembly 108 that is attached to the frame 102 at the rear of the snowbike 100. The track assembly 108, in certain examples, includes an endless track 110. The track assembly 108, as known to those of skill in the art, includes a tunnel 111 that supports suspension components, slide rails, bogey wheels, etc., and connects the endless track 110 with the propulsion unit 103 via various drive components that will be discussed in greater detail below.

The propulsion unit 103 is disposed within the frame 102 and positioned underneath the seat 116. The propulsion unit 103, in certain examples, is a two-or four-stroke engine with one or more cylinders that is sourced from either an off-road motorcycle or a snowmobile. In other examples, the propulsion unit 103 is a custom-built engine. An exhaust pipe 114 may extend from the front of the propulsion unit 103 to a position that expels exhaust gasses towards the rear of the snowbike 100. In certain examples, the exhaust pipe 114 is routed along the bottom of the propulsion unit 103. In other examples, the propulsion unit 103 is an electric motor and battery system.

In certain examples, a CVT clutch system 113 is mounted on top of the tunnel 111 of the track assembly 108. The CVT clutch system 113, in certain examples, includes a primary clutch 410 and a secondary clutch 412. The CVT clutch system 113, as depicted, is disposed to the rear of the propulsion unit 103 above the endless track 110 with the primary clutch 410 and the secondary clutch 412 facing the right side of the snowbike 100. In other words, the primary clutch 410 and the secondary clutch 412 are accessible or serviceable from the right side of the snowbike 100. Stated differently, the primary clutch 410 is coupled to a shaft that extends to the left side of the snowbike 100. A clutch cover 118 may be provided to protect the primary clutch 410 and the secondary clutch 412.

The track assembly 108, in certain examples, has an endless track 110 that is thirteen-inches wide, has two-inch paddle tracks, a 2.86 pitch, and is one-hundred thirty-seven inches long. In certain examples, the track assembly 108 uses an endless track 110 that uses a three-inch paddle track. The track assembly 108 may use an endless track 110 that is one-hundred twenty-nine inches long. In other examples, the track assembly 108 is a track assembly kit made for snowmobiles or snowbikes.

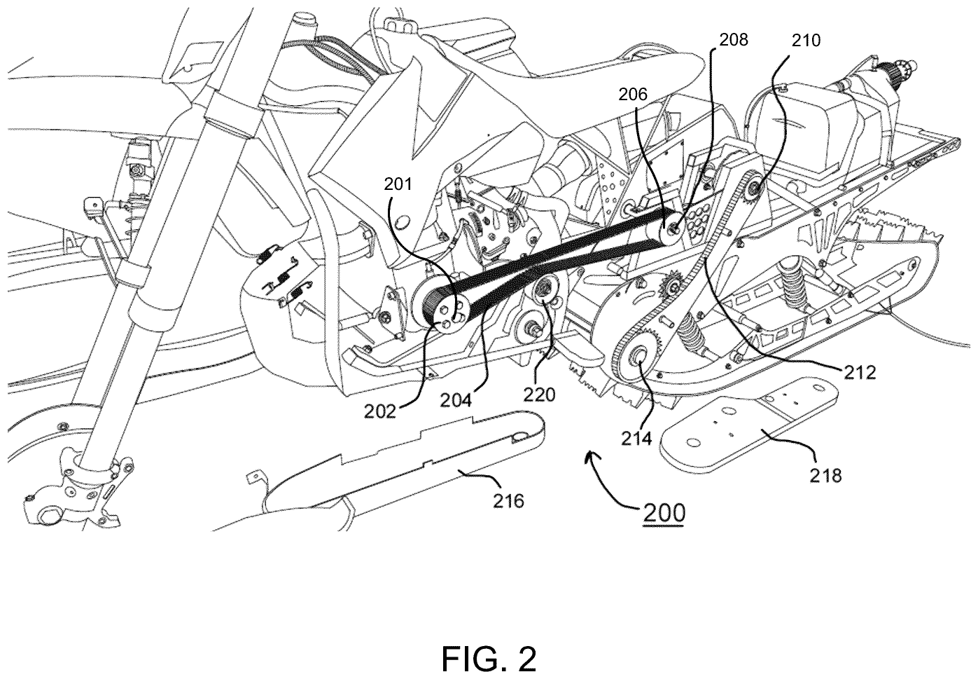

FIG. 2 is a perspective view diagram illustrating one example of a drive system 200 of a snowbike 100. The drive system 200, in certain examples, includes a driveshaft 201 driven by the propulsion unit 103. The driveshaft 201 may be a crankshaft. In alternative examples, the driveshaft 201 may be a transmission output shaft if the propulsion unit 103 is equipped with a transmission. In certain examples, the driveshaft 201 extends outward from the propulsion unit 103 on the left side of the snowbike 100. Similarly, the driveshaft 201 may extend outward from the right side of the propulsion unit 103. As will be discussed in greater detail below, the driveshaft 201 may be positioned on the opposite side of the snowbike 100 from the CVT clutch system 113.

In certain examples, a belt drive gear 202 is attached to the propulsion unit 103 by the driveshaft 201. The belt drive gear 202 is configured to drive a belt pulley 206 via a belt 204. The belt drive gear 202 may be toothed to correspond with a toothed belt 204. In other examples, the belt 204 is not toothed. The belt drive gear 202 is configured to transfer a driving force from the propulsion unit 103 to the belt pulley 206 which is coupled to an end of a first jackshaft 208. The first jackshaft 208 is coupled at an opposite end to the primary clutch 410. As such, rotation of the belt pulley 206 causes rotation of the primary clutch 410.

A second jackshaft 210 is coupled at a first end to the secondary clutch 412 and at a second end with a chain gear 211. The chain gear 211 translates a rotational force from the second jackshaft 210 through a chain 212 to drive the endless track. In some examples, the drive system 200 uses the chain 212 to engage the track driveshaft 214. The track driveshaft 214, in some examples, rotate one or more track drivers that engage the endless track 110 and propel the snowbike 100 forward.

In some examples, a drive system cover 216 covers the belt drive gear 202, the belt 204, the belt pulley 206, and the first jackshaft 208. In some examples, a track drive cover 218 covers the chain 212, the track driveshaft 214, and the secondary jackshaft 210. The drive system cover 216 and the track drive cover 218 may be made of any protective material, but in some examples are formed of plastic, metal, metal alloys, or composite materials. The clutch cover 118 from FIG. 1 may also be made from any protective material such as plastic, aluminum, or carbon fiber.

An automatic tensioner 220, in certain examples, is coupled to either the frame 102 or the propulsion unit 103 and configured to apply a force to the belt 204 to remove slack in the belt 204. Slack is introduced by inherent flex in the belt drive 204 and slack is introduced when the snowbike 100 changes speed. Rubber mounts being used to mount the propulsion unit 103 can also lead to additional slack in the belt drive 204 when the snowbike 100 turns or changes speed. Slack in the belt drive 204 can lead to a loss of power and can cause damage to the belt drive 204. In some examples, the automatic tensioner 220 is configured to maintain tension on the belt 204 to prevent slack in the belt drive 204 during operation. In some examples the automatic tensioner 220 may be an automatic tensioner from an automobile. Although depicted here as being positioned outside of the belt 204 and pushing the belt 204 inward, it is also contemplated that the automatic tensioner is positioned within the belt 204 and applies a tensioning force outward on the belt 204. It is contemplated that the automatic tensioner may be positioned outside of the belt 204, or any suitable position.

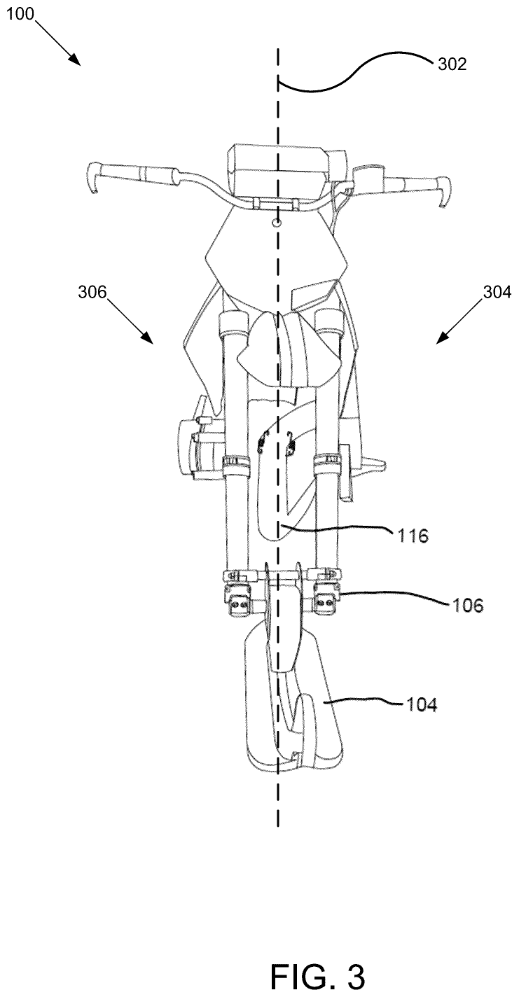

FIG. 3 is a front view diagram of the snowbike 100, in accordance with examples of the subject disclosure. By mounting the primary clutch 410 and the secondary clutch 412 above the endless track 110 as described above with reference to FIG. 1, the snowbike 100, in some examples, is constructed with a frame 102 that is narrower than a frame constructed for an engine with a clutch mounted on the side of the propulsion unit 103. In some examples, the frame 102 is 8-10 inches narrower than prior art snowmobile or snowbike frames. The exhaust pipe 114 wrapping underneath the bottom of the engine also contributes to narrow construction of the frame 102, and the overall snowbike 100, and keeps the exhaust pipe 114 out of the way of the rider's legs. Beneficially, a narrow frame 102 allows for increased maneuverability, decreased drag in the snow, increased visual appeal, and increased rider comfort.

The narrow configuration of a snowbike 100 with a CVT clutch system is possible because of the positioning of drive components described above with reference to FIG. 2. Beneficially, the first jackshaft 208 and the second jackshaft 210 operate to transfer the rotational driving force from the propulsion unit 103 from one side of the snowbike to the other, and then back again. A vertical plane 302 aligned with a central longitudinal axis bisects the snowbike 100 into a first side 304 and a second side 306. The first side 304 may be referred to as the left side with reference to a rider seated on the snowbike, and similarly the second side 306 may be referred to as the right side.

Beneficially, the examples of the subject disclosure minimize the width of the snowbike 100 in the area of the front motorcycle portion by transferring the driving force of the driveshaft 201 from the left side 304 via the first jackshaft 208 to the CVT clutch system 113 on the right side 306, and then back to the left side 304 via the second jackshaft 210.

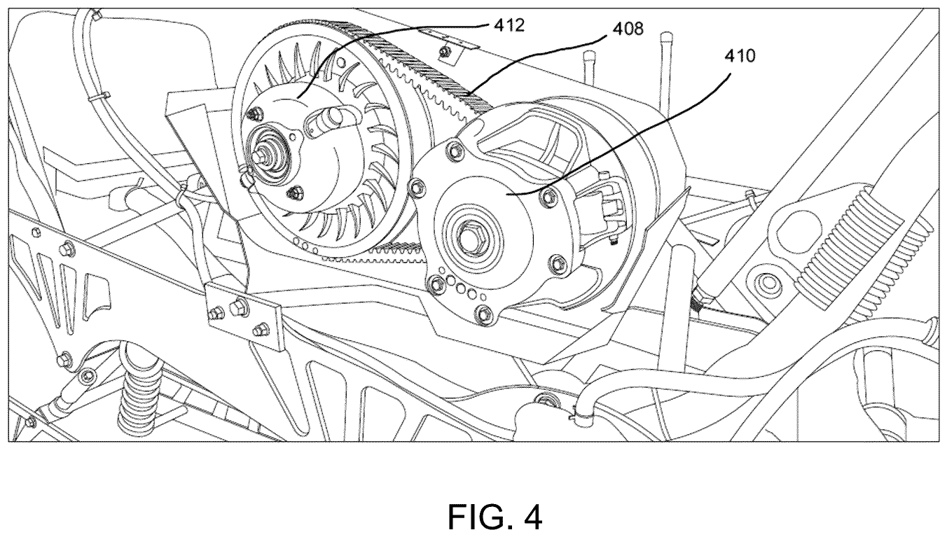

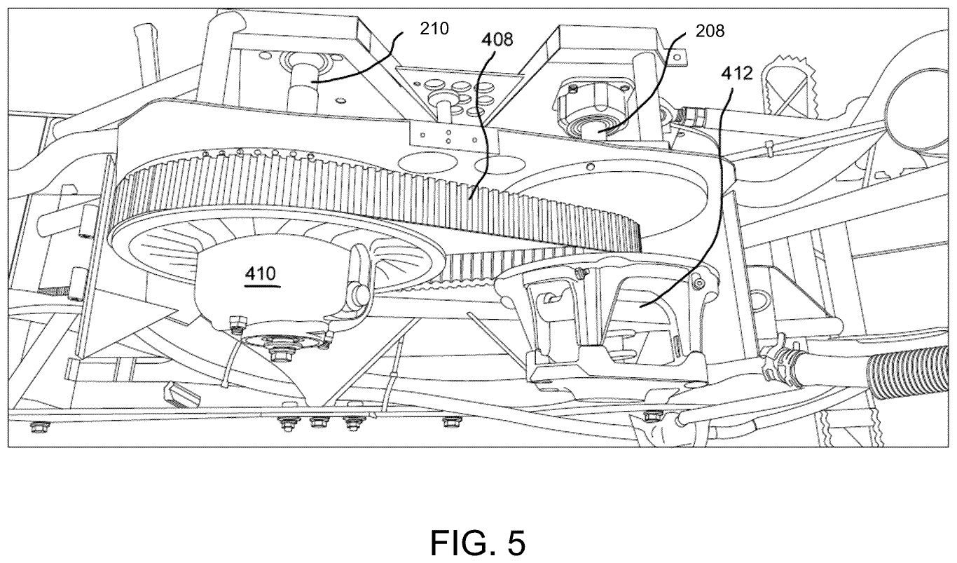

FIGS. 4 and 5 are perspective views diagrams illustrating examples of the primary and secondary clutches 410, 412 of the snowbike 100, in accordance with examples of the subject disclosure. In certain examples, the primary clutch 410 is mounted in front of the secondary clutch 412 with reference to the frame 102. The primary clutch 410 and the secondary clutch 412 are both centrifugal clutches in some examples allowing the rider to not have to shift gears while riding and always remain in an optimal power band.

In other examples, the primary and secondary clutches 410, 412 are sheaves clutches. In the depicted example, a v-belt 408 is shown that connects the primary clutch 410 and the secondary clutch 412 and engages the secondary clutch 412. In some examples the primary and secondary clutches 410, 412 are disposed substantially to a side of the vertical plane 302 that is opposite to the side of the driveshaft 201. Stated differently, if the driveshaft is disposed on the left side 304, then in certain examples the primary clutch 410 and the secondary clutch 412 are substantially mounted on the right side 306 of the vertical plane. As used herein, the terms “disposed substantially” and “substantially mounted” refer to the center of mass of either the primary clutch 410 and/or the secondary clutch 412 being positioned to a side of the vertical plane. For the avoidance of confusion, portions of the primary clutch 410 and/or the secondary clutch 412 may extend through the vertical plane 302 so long as the centers of mass are disposed to a side of the vertical plane 302. Although the above examples describe the driveshaft on the left side, and the clutches on the right side, it is contemplated that the positions of the components may be reversed.

As described above, the first jackshaft 208 and the second jackshaft 210 are spinning shafts configured for transferring rotational forces from the propulsion unit 103 to the endless track. Each of the first jackshaft 208 and the second jackshaft 210 are configured with a first end and a second end. The first end of the first jackshaft 208 is coupled to the primary clutch 412. Similarly, the first end of the second jackshaft 210 is coupled to the secondary clutch 412. In certain examples, the first ends of the jackshafts 208, 210 are disposed on the right side 306 of the vertical plane 302. In other examples, the first ends of the jackshafts 208, 210 are disposed on a side of the vertical plane 302 that is opposite an end of the driveshaft 201 that is coupled to drive gear.

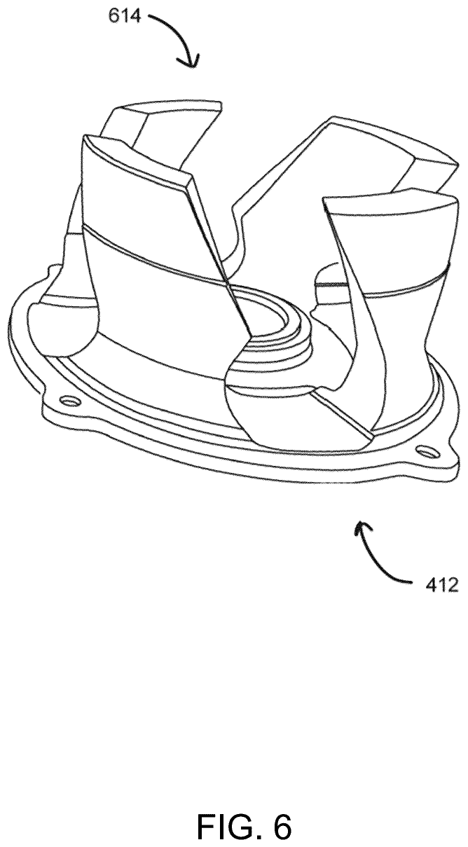

FIG. 6 is a perspective view diagram illustrating one example of a reverse-cut helix 614 of a secondary clutch 412, in accordance with examples of the subject disclosure. Standard snowmobile secondary clutches can rotate in either direction, but their standard-cut helixes only allow for full-shifting in one direction. The reverse-cut helix 614 allows a snowmobile secondary clutch 412 to rotate in the reverse direction normally allowed by the standard-cut helix and allows for full shifting in the reverse direction. The reverse-cut helix 614 allows the secondary clutch 412 to be mounted on the right side of the snowbike 100 instead of the left side of the snowbike 100, which is the standard for snowmobiles. In some examples, a standard-cut helix is used with the secondary clutch 412 and is mounted on the left side of the snowbike 100.

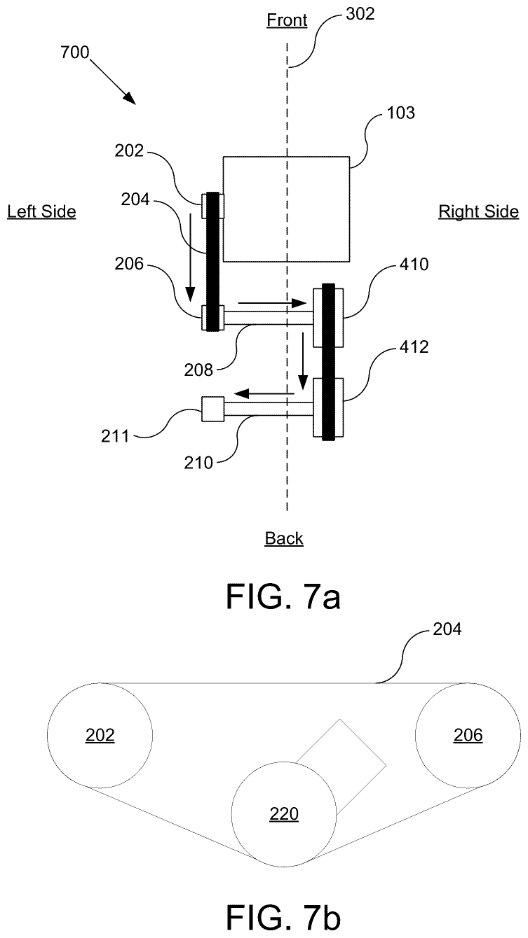

FIG. 7a is a schematic block diagram illustrating one example of a top-down view of the powertrain 700 of the snowbike 100, in accordance with examples of the subject disclosure. As described previously, the vertical plane 302 bisects the snowbike 100 with the driveshaft 201 and the belt drive gear 202 being disposed on a first side of the vertical plane and the primary clutch 410 and secondary clutch 412 being substantially disposed on the opposite side of the vertical plane 302.

Stated another way, the output end of the driveshaft 201 is positioned on one side of the vertical plane 302 and the ends of the jackshafts 208, 210 that connect with the clutches 410, 412 are positioned on the opposite side of the vertical plane. Various arrows graphically depict the transfer of the driving force from the propulsion unit through the powertrain 700 to chain gear 211 which transfers the driving force to the track driveshaft. In certain examples, the driving, rotational force generated by the propulsion unit 103 is transmitted across the vertical plane 302 at least twice before reaching the chain gear 211.

FIG. 7b is a schematic block diagram illustrating one example of the automatic tensioner 220 in accordance with examples of the subject disclosure. As described above, the automatic tensioner 220 may be mounted to the frame or propulsion unit within a perimeter defined by the belt 204. In such a configuration, the automatic tensioner 220 pushes outward on the belt 204 to maintain proper tension of the belt 204. In other examples, such as those described above with reference to FIG. 2, the automatic tensioner is positioned outside the perimeter of the belt and pushes inward to tension the belt.

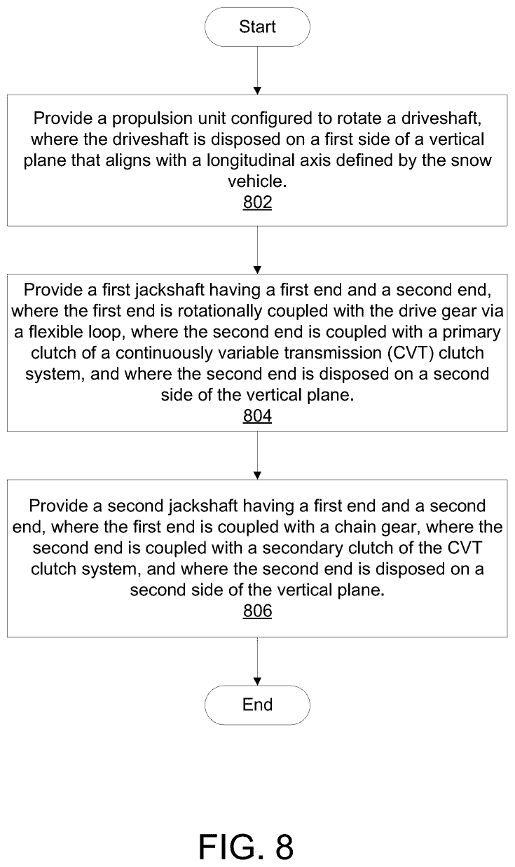

FIG. 8 is a schematic flowchart diagram illustrating one method of propelling a snow vehicle in accordance with examples of the subject disclosure. In certain examples, the method starts at block 802 and a propulsion unit is provided and configured to rotate a driveshaft, where the driveshaft has an end configured to couple to a drive gear, where the end is disposed on a first side of a vertical plane that aligns with a longitudinal axis defined by the snow vehicle.

At block 804, the method continues and a first jackshaft is provided having a first end and a second end, where the first end is rotationally coupled with the drive gear via a flexible loop, where the second end is coupled with a primary clutch of a continuously variable transmission (CVT) clutch system, and where the second end is disposed on a second side of the vertical plane. At block 806, a second jackshaft is provided having a first end and a second end, where the first end is coupled with a chain gear, where the second end is coupled with a secondary clutch of the CVT clutch system, and where the second end is disposed on a second side of the vertical plane.

The present disclosure may be embodied in other specific forms without departing from its spirit or essential characteristics. The described examples are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A powertrain for a snow vehicle, the powertrain comprising:
a propulsion unit configured to rotate a driveshaft, where the driveshaft has an end configured to couple to a drive gear, where the end is disposed on a first side of a vertical plane that aligns with a longitudinal axis defined by the snow vehicle;
a first jackshaft having a first end and a second end, where the first end is rotationally coupled with the drive gear via a flexible loop, where the second end is coupled with a primary clutch of a continuously variable transmission (CVT) clutch system, and where the second end is disposed on a second side of the vertical plane; and
a second jackshaft having a first end and a second end, where the first end is coupled with a chain gear, where the second end is coupled with a secondary clutch of the CVT clutch system, and where the second end is disposed on a second side of the vertical plane.

2. The powertrain of claim 1, further comprising an automatic tensioner configured to maintain tension on the flexible loop, and where the automatic tensioner is disposed within a perimeter of the flexible loop and applies a tensioning force outward on the flexible loop.

3. The powertrain of claim 1, further comprising an automatic tensioner configured to maintain tension on the flexible loop, and where the automatic tensioner is disposed outside a perimeter of the flexible loop and applies a tensioning force inward on the flexible loop.

4. The powertrain of claim 1, where the propulsion unit is located forward relative to an endless track, and the primary clutch and the secondary clutch are disposed above the endless track.

5. The powertrain of claim 1, further comprising a v-belt configured to couple the primary clutch and the secondary clutch.

6. The powertrain of claim 5, further comprising a chain that is configured to couple the chain gear with an endless track driveshaft.

7. The powertrain of claim 6, further comprising one or more drivers coupled to the endless track driveshaft, where the one or more drivers are configured to engage an endless track and propel the snow vehicle forward.

8. The powertrain of claim 1, where the propulsion unit is dual cylinder internal combustion engine.

9. The powertrain of claim 1, where the propulsion unit is an internal combustion engine, and the powertrain further comprises an exhaust pipe coupled to a front portion of the internal combustion engine and configured to pass below the internal combustion engine.

10. The powertrain of claim 1, where the secondary clutch comprises a reverse-cut helix for counter-clockwise operation of the secondary clutch.

11. The powertrain of claim 1, wherein the snow vehicle further comprises a single ski.

12. A snow vehicle comprising:
a frame configured to maintain a powertrain and couple at a front end to a steering mechanism and couple at a rear end to an endless track, where the powertrain comprises:
a propulsion unit configured to rotate a driveshaft, where the driveshaft has an end configured to couple to a drive gear, where the end is disposed on a first side of a vertical plane that aligns with a longitudinal axis defined by the snow vehicle;
a first jackshaft having a first end and a second end, where the first end is rotationally coupled with the drive gear via a flexible loop, where the second end is coupled with a primary clutch of a continuously variable transmission (CVT) clutch system, and where the second end is disposed on a second side of the vertical plane; and
a second jackshaft having a first end and a second end, where the first end is coupled with a chain gear, where the second end is coupled with a secondary clutch of the CVT clutch system, and where the second end is disposed on a second side of the vertical plane.

13. The snow vehicle of claim 12, further comprising an automatic tensioner configured to maintain tension on the flexible loop, and where the automatic tensioner is disposed within a perimeter of the flexible loop and applies a tensioning force outward on the flexible loop.

14. The snow vehicle of claim 12, where the propulsion unit is located forward relative to an endless track, and the primary clutch and the secondary clutch are disposed above the endless track.

15. The snow vehicle of claim 12, further comprising a v-belt configured to couple the primary clutch and the secondary clutch.

16. The snow vehicle of claim 15, further comprising a chain that is configured to couple the chain gear with an endless track driveshaft.

17. The snow vehicle of claim 16, further comprising one or more drivers coupled to the track driveshaft, where the one or more drivers are configured to engage the endless track and propel the snow vehicle forward.

18. The snow vehicle of claim 12, where the propulsion unit is an internal combustion engine, and the powertrain further comprises an exhaust pipe coupled to a front portion of the internal combustion engine and configured to pass below the internal combustion engine.

19. The snow vehicle of claim 12, where the secondary clutch comprises a reverse-cut helix for counter-clockwise operation of the secondary clutch.

20. A method for propelling a snow vehicle, the method comprising:
providing a propulsion unit configured to rotate a driveshaft, where the driveshaft has an end configured to couple to a drive gear, where the end is disposed on a first side of a vertical plane that aligns with a longitudinal axis defined by the snow vehicle;
providing a first jackshaft having a first end and a second end, where the first end is rotationally coupled with the drive gear via a flexible loop, where the second end is coupled with a primary clutch of a continuously variable transmission (CVT) clutch system, and where the second end is disposed on a second side of the vertical plane; and
providing a second jackshaft having a first end and a second end, where the first end is coupled with a chain gear, where the second end is coupled with a secondary clutch of the CVT clutch system, and where the second end is disposed on a second side of the vertical plane.
